(19) United States
(12) Patent Application Publication
(10) Pub. No.: US 2024/0419119 A1
(43) Pub. Date: Dec. 19, 2024

(54) IMAGE FORMING APPARATUS

(71) Applicant: FUJIFILM Business Innovation Corp., Tokyo (JP)

(72) Inventors: Mariko SUZUKI, Kanagawa (JP); Masaaki Yamaura, Kanagawa (JP); Akihiro Takahashi, Kanagawa (JP)

(73) Assignee: FUJIFILM Business Innovation Corp., Tokyo (JP)

(21) Appl. No.: 18/532,422

(22) Filed: Dec. 7, 2023

(30) Foreign Application Priority Data
Jun. 15, 2023 (JP) 2023-098267

(51) Int. Cl. G03G 21/00; G03G 15/00

(52) U.S. Cl. CPC G03G 21/0094; G03G 15/50

(57) ABSTRACT

An image forming apparatus includes: an image holding section; a transfer section that transfers an image held by the image holding section onto a medium; a supply section that supplies a transfer assist material for assisting the transfer to the image holding section; a detection section that detects an amount of the transfer assist material held by the image holding section; and a holding amount control section that controls an amount of the transfer assist material to be held by the image holding section based on a detection result of the detection section.

### CROSS-REFERENCE TO RELATED APPLICATIONS

This application is based on and claims priority under 35 USC 119 from Japanese Patent Application No. 2023-098267 filed Jun. 15, 2023.

### BACKGROUND

### (i) Technical Field

The present invention relates to an image forming apparatus.

### (ii) Related Art

In image forming apparatuses that perform image formation by electrostatically transferring and fixing an image of a developer on an image holding section onto a medium such as paper, a technique described in JP2008-175849A below is known.

JP2008-175849A describes the technique for suppressing transfer failure by installing a lubricant applying device (3) on the upstream side of a cleaning blade (8a) along a rotation direction of a photoconductor (1) and applying a lubricant to a surface of the photoconductor (1) by the lubricant applying device (3) to reduce a friction coefficient with respect to a toner on the photoconductor (1). In JP2008-175849A, a solid lubricant (3b) is scraped off by a brush roller (3a), and the scraped lubricant is applied to the photoconductor (1) by the brush roller (3a). In JP2008-175849A, the lubricant is randomly applied to the entire circumference of the photoconductor (1) by controlling on and off of driving of the brush roller (3a) to suppress the lubricant from being applied to a specific portion in the circumferential direction, thereby suppressing occurrence of unevenness of the lubricant.

### SUMMARY

Aspects of non-limiting embodiments of the present disclosure relate to an image forming apparatus that stabilizes image quality as compared with a case where a holding amount of a transfer assist material on an image holding section is not checked.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus comprising:
an image holding section;
a transfer section that transfers an image held by the image holding section onto a medium;
a supply section that supplies a transfer assist material for assisting the transfer to the image holding section;
a detection section that detects an amount of the transfer assist material held by the image holding section; and
a holding amount control section that controls an amount of the transfer assist material to be held by the image holding section based on a detection result of the detection section.

### BRIEF DESCRIPTION OF THE DRAWINGS

FIG. 1 is an overall explanatory view of an image forming apparatus of a first example.

FIG. 2 is an enlarged explanatory view of the image forming apparatus of the first example.

FIG. 3 is an explanatory view of a transfer assist material supply device of the first example.

FIGS. 4A to 4C are explanatory views of movements of an applying device and a belt cleaner in which FIG. 4A is an explanatory view of a state where both the applying device and the belt cleaner are moved to a high contact pressure position, FIG. 4B is an explanatory view of a state where both the applying device and the belt cleaner are moved to a medium contact pressure position, and FIG. 4C is an explanatory view of a state where both the applying device and the belt cleaner are moved to a low contact pressure position.

FIG. 5 is an explanatory diagram of a control unit of the first example.

FIG. 6 is an explanatory view of an example of the relationship between an adhesion amount of the transfer assist material and an output of a density sensor, and is a graph in which the horizontal axis represents a coating rate and the vertical axis represents an output value of the density sensor.

FIG. 7 is an explanatory diagram of a control unit of a second example, which corresponds to FIG. 5 of the first example.

FIG. 8 is an explanatory view of a transfer assist material supply device of a third example, which corresponds to FIG. 3 of the first example.

FIG. 9 is an explanatory diagram of a control unit of the third example, which corresponds to FIG. 5 of the first example.

### DETAILED DESCRIPTION

Although specific examples of embodiments of the present invention (hereinafter, referred to as examples) will be described in detail next with reference to the drawings, the present invention is not to be limited to the following examples.

In the drawings, it is assumed that a front-rear direction is an X-axis direction, a left-right direction is a Y-axis direction, an up-down direction is a Z-axis direction, and directions or sides indicated by arrows X, −X, Y, −Y, Z, and −Z are respectively front, rear, right, left, above, and below, or the front side, the rear side, the right side, the left side, the upper side, and the lower side in order to facilitate understanding of the following description.

In addition, in the drawings, it is assumed that “O” with “⋅” therein represents an arrow directed from the back side to the front side of the paper surface, and “O” with “x” therein represents an arrow directed from the front side to the back side of the paper surface.

In the following description using the drawings, illustrations of members other than those necessary for the description are omitted as appropriate for ease of understanding.

### FIRST EXAMPLE

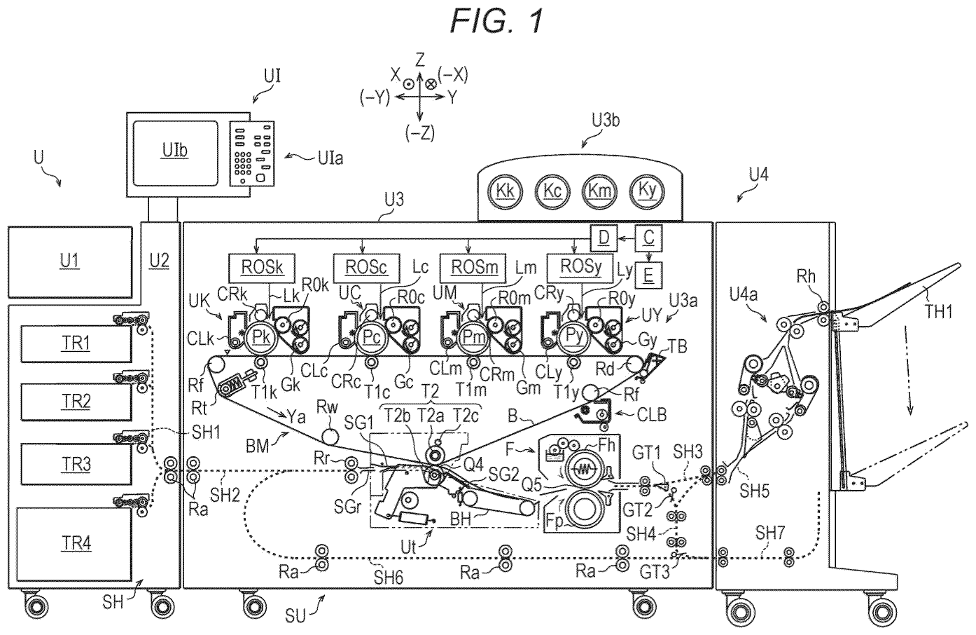

FIG. 1 is an overall explanatory view of an image forming apparatus of a first example.

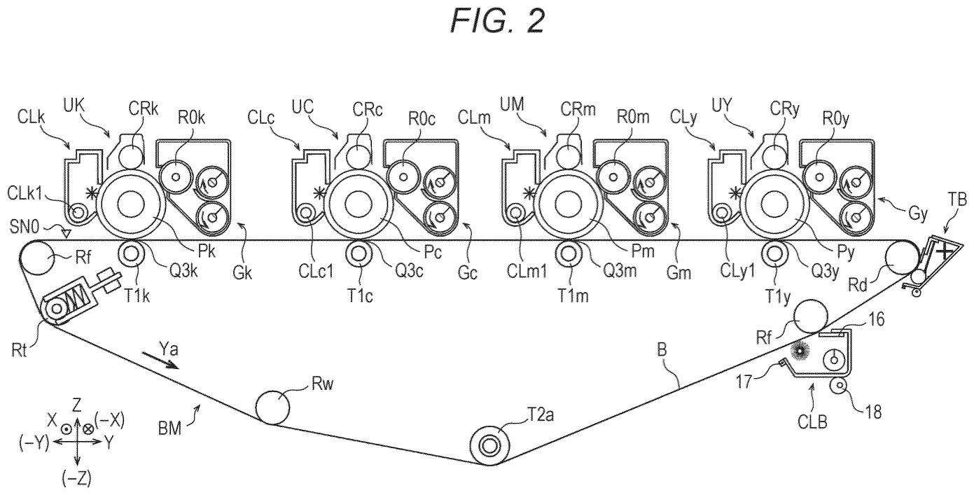

FIG. 2 is an enlarged explanatory view of the image forming apparatus of the first example.

In FIG. 1, a copier U which is an example of the image forming apparatus includes a user interface UI which is an example of an operation unit, a scanner U1 which is an example of an image reading device, a feeder U2 which is an example of a medium supply device, an image forming unit U3 which is an example of an image recording device, and a medium processing device U4.

### Description of User Interface UI

The user interface UI includes input buttons UIa used to start copying, set the number of copies, and the like. In addition, the user interface UI includes a display UIb on which contents input by the input button UIa and a state of the copier U are displayed.

### Description of Feeder U2

In FIG. 1, the feeder U2 includes sheet feed trays TR1, TR2, TR3, and TR4, which are examples of a medium container. The feeder U2 further includes a medium supply path SH1 through which a recording sheet S, which is an example of an image recording medium, is taken out from each of the sheet feed trays TR1 to TR4 and is transported to the image forming unit U3.

### Description of Image Forming Unit U3 and Medium Processing Device U4

In FIG. 1, the image forming unit U3 includes an image recording unit U3a that records an image on the recording sheet S transported from the feeder U2 based on a document image read by the scanner U1.

In FIGS. 1 and 2, a drive circuit D for latent image forming devices in the image forming unit U3 outputs drive signals based on image information input from the scanner U1 to the latent image forming devices ROSy, ROSm, ROSc, and ROSk for yellow (Y), magenta (M), cyan (C), and black (K) at preset timings. Photoconductor drums Py, Pm, Pc, and Pk, which are examples of an image holding section, are disposed below the latent image forming devices ROSy to ROSK, which are examples of a writing section.

Surfaces of the rotating photoconductor drums Py to Pk are uniformly charged by charging rollers CRy, CRm, CRc, and CRk, respectively, which are examples of a charging section. Electrostatic latent images are formed on the charged surfaces of the photoconductor drums Py to Pk by laser beams Ly, Lm, Lc, and Lk, which are examples of latent image writing light, output from the latent image forming devices ROSy to ROSK, respectively. The electrostatic latent images on the surfaces of the photoconductor drums Py to Pk are developed into toner images, which are examples of visible images of yellow (Y), magenta (M), cyan (C), and black (K), respectively, by developing devices Gy, Gm, Gc, and Gk which are examples of a developing section.

In the developing devices Gy to Gk, developers consumed by the development are replenished respectively from toner cartridges Ky, Km, Kc, and Kk which are examples of a developer storage section. The toner cartridges Ky to Kk are detachably attached to a developer replenishing device U3b.

The toner images on the surfaces of the photoconductor drums Py to Pk are sequentially superimposed and transferred onto an intermediate transfer belt B, which is an example of an intermediate transfer section, in primary transfer regions Q3y, Q3m, Q3c, and Q3k by primary transfer rollers T1y, T1m, T1c, and T1k which are examples of a transfer section and examples of a primary transfer machine, whereby a color toner image, which is an example of a multi-color visible image, is formed on the intermediate transfer belt B. The color toner image formed on the intermediate transfer belt B is transported to a secondary transfer region Q4.

In a case where there is only image information of K color, only the photoconductor drum Pk and the developing device Gk of K color are used, and only the toner image of K color is formed.

Residues such as a residual developer and paper dust attached to the surfaces of the photoconductor drums Py to Pk after the primary transfer are removed by drum cleaners CLy, CLm, CLc, and CLk, which are examples of a cleaning section for the image holding section.

In the first example, the photoconductor drum Pk, the charging roller CRk, and the drum cleaner CLK are integrated as a K-color photoconductor unit UK which is an example of an image holder unit. Similarly, for the other colors Y, M, and C, the photoconductor drums Py, Pm, and Pc, the charging rollers CRy, CRm, and CRc, and the drum cleaners CLy, CLm, and CLc constitute photoconductor units UY, UM, and UC, respectively.

In addition, the K-color photoconductor unit UK and the developing device Gk including the developing roller R0k, which is an example of a developer holding section, constitute a K-color image forming section UK+Gk. Similarly, the photoconductor units UY, UM, and UC of colors Y, M, and C and the developing devices Gy, Gm, and Gc having the developing rollers R0y, R0m, and R0c constitute image forming sections UY+Gy, UM+Gm, and UC+Gc of colors Y, M, and C, respectively.

A belt module BM, which is an example of an intermediate transfer section, is disposed below the photoconductor drums Py to Pk. The belt module BM includes the intermediate transfer belt B which is the example of the intermediate transfer section, a driving roller Rd which is an example of a driving section for the intermediate transfer section, a tension roller Rt which is an example of a tensioning section, a walking roller Rw which is an example of a meandering prevention section, a plurality of idler rollers Rf which are examples of driven sections, a backup roller T2a which is an example of an opposing section, and the primary transfer rollers T1y to T1k. The intermediate transfer belt B is supported so as to be rotatably movable in a direction of an arrow Ya.

Note that the primary transfer rollers T1y, T1m, and T1c of Y, M, and C colors in the first example are supported so as to be capable of approaching and being separated from the photoconductor drums Py, Pm, and Pc, respectively. In the case of multi-color printing (color printing), the primary transfer rollers T1y, T1m, and T1c of colors Y, M, and C approach the photoconductor drums Py to Pc to sandwich the intermediate transfer belt B with a predetermined contact pressure. On the other hand, in the case of single color printing (monochrome printing) of only black, the primary transfer rollers T1y, T1m, and T1c of colors Y, M, and C are separated from the photoconductor drums Py to Pc.

A secondary transfer unit Ut is disposed below the backup roller T2a. The secondary transfer unit Ut includes a secondary transfer roller T2b which is an example of a secondary transfer section. The secondary transfer region Q4 is formed by a region where the secondary transfer roller T2b is in contact with the intermediate transfer belt B. The backup roller T2a, which is the example of the opposing member, opposes the secondary transfer roller T2b with the intermediate transfer belt B interposed therebetween. A contact roller T2c, which is an example of a power supply section, is in contact with the backup roller T2a. A secondary transfer voltage having the same polarity as a toner charging polarity is applied to the contact roller T2c.

The backup roller T2a, the secondary transfer roller T2b, and the contact roller T2c constitute a secondary transfer machine T2 which is an example of a transfer section.

Note that the secondary transfer unit Ut of the first example is configured to be movable in a direction of approaching and being separated from the intermediate transfer belt B. The secondary transfer unit Ut moves in accordance with a type of the recording sheet S to be used so as to change the contact pressure between the secondary transfer roller T2b and the intermediate transfer belt B. For example, when thick paper is used, the contact pressure is reduced as compared with a case where plain paper is used, so that an impact at the time when a leading end of the thick paper enters the secondary transfer region Q4 can be alleviated.

A medium transport path SH2 is disposed below the belt module BM. The recording sheet S fed from the medium supply path SH1 of the feeder U2 is transported to a registration roller Rr which is an example of a transport timing adjustment section by a transport roller Ra which is an example of a medium transport section. The registration roller Rr transports the recording sheet S to the downstream side in accordance with a timing when a toner image formed on the intermediate transfer belt B is transported to the secondary transfer region Q4. The recording sheet S sent out by the registration roller Rr is guided by a registration-side sheet guide SGr and a pre-transfer sheet guide SG1, and is transported to the secondary transfer region Q4.

The toner image on the intermediate transfer belt B is transferred onto the recording sheet S by the secondary transfer machine T2 when passing through the secondary transfer region Q4. In the case of a color toner image, toner images that have been primarily transferred to the surface of the intermediate transfer belt B in an overlapping manner are secondarily transferred to the recording sheet S in a collective manner.

The primary transfer rollers T1y to T1k, the secondary transfer machine T2, and the intermediate transfer belt B constitute a transfer device (transfer section) T1y to T1k+T2+B of the first example.

The intermediate transfer belt B after the secondary transfer is cleaned by a belt cleaner CLB, which is an example of a cleaning section for the intermediate transfer section, disposed on the downstream side of the secondary transfer region Q4. The belt cleaner CLB removes the residues, from the intermediate transfer belt B, such as the developer and paper dust remaining without being transferred in the secondary transfer region Q4.

In the copier U of the first example, an applying device TB, which is an example of a supply section, is disposed on the downstream side of the belt cleaner CLB in a rotation direction of the intermediate transfer belt B. The applying device TB supplies a transfer assist material to the intermediate transfer belt B. When a layer of the transfer assist material is formed on the surface of the intermediate transfer belt B, a toner image is held on a surface of the layer of the transfer assist material. In a case where the layer of the transfer assist material is present, transfer from the intermediate transfer belt B to the recording sheet S is likely to occur as compared with a case where the layer of the transfer assist material is not present. Thus, in a case where the recording sheet S is a sheet type, such as Japanese paper or embossed paper, on which transfer failure is likely to occur, the occurrence of transfer failure is suppressed by applying the transfer assist material.

A density sensor SN0, which is an example of a detection section, reading an image on the surface of the intermediate transfer belt B is disposed at a position on the downstream side of the most downstream primary transfer roller T1k along the rotation direction of the intermediate transfer belt B. Note that the density sensor SN0 also serves as a sensor for adjusting the density of an image in the first example, but the invention is not limited thereto. For example, a dedicated sensor for detecting a holding amount of the transfer assist material may also be additionally installed. In this case, a location where the sensor is installed is not limited to the downstream side of the most downstream primary transfer region Q3k, and can be changed to the downstream side of the secondary transfer region Q4, between the belt cleaner CLB and the applying device TB, or between the applying device TB and the most upstream primary transfer region Q3y.

In addition, the configuration in which the belt cleaner CLB and the applying device TB are disposed at separated positions is exemplified in the first example, but the invention is not limited thereto. For example, it is also possible to save space facilitate replacement to improve a maintenance property by adopting a configuration in which a housing of the belt cleaner CLB and the applying device TB are integrated into a single unit.

The recording sheet S to which a toner image has been transferred is guided by a post-transfer sheet guide SG2, and is sent to a belt transport device BH which is an example of the medium transport section. The belt transport device BH transports the recording sheet S to a fixing device F.

The fixing device F includes a heating roller Fh which is an example of a heating section and a pressing roller Fp which is an example of a pressing section. The recording sheet S is transported to a fixing region Q5 which is a region where the heating roller Fh and the pressing roller Fp are in contact with each other. The toner image on the recording sheet S is heated and pressurized by the fixing device F to be fixed when passing through the fixing region Q5.

The image forming sections UY+Gy to UK+Gk, the transfer devices T1y to T1k+T2+B, and the fixing device F constitute the image recording unit U3a which is an example of an image recording section of the first example.

On the downstream side of the fixing device F, a switching gate GT1 which is an example of a switching section is provided. The switching gate GT1 selectively switches the recording sheet S that has passed through the fixing region Q5 to either a discharge path SH3 or a reverse path SH4 on the side closer to the medium processing device U4. The recording sheet S that has been transported to the discharge path SH3 is transported to a sheet transport path SH5 of the medium processing device U4. A curl correcting member U4a which is an example of a warp correction section is disposed in the sheet transport path SH5. The curl correcting member U4a corrects a warp, that is, a so-called curl of the recording sheet S which has been carried in. The recording sheet S whose curl has been corrected is discharged by a discharge roller Rh, which is an example of a medium discharge member, to a discharge tray TH1, which is an example of a medium discharge unit, with an image-fixed surface of the sheet facing upward.

The recording sheet S that has been transported toward the reverse path SH4 of the image forming unit U3 by the switching gate GT1 passes through a second gate GT2, which is an example of a switching member, and is transported to the reverse path SH4 of the image forming unit U3.

At this time, in a case where the image-fixed surface of the recording sheet S is to be discharged downward, a transport direction of the recording sheet S is reversed after a rear end of the recording sheet S in the transport direction has passed through the second gate GT2. Here, the second gate GT2 of the first example is configured using a thin film-shaped elastic member. Therefore, the second gate GT2 temporarily causes the recording sheet S that has been transported to pass through the reverse path SH4 as it is, and guides the recording sheet S toward the discharge path SH3 and the sheet transport path SH5 when the passing sheet S is reversed, that is, switched back. Then, the recording sheet S switched back passes through the curl correcting member U4a, and is discharged to the discharge tray TH1 in a state where the image-fixed surface faces downward.

A circulation path SH6 is connected to the reverse path SH4 of the image forming unit U3, and a third gate GT3 which is an example of the switching section is disposed at such a connecting portion. In addition, a downstream end of the reverse path SH4 is connected to a reverse path SH7 of the medium processing device U4.

The recording sheet S that has been transported to the reverse path SH4 through the switching gate GT1 is transported toward the reverse path SH7 of the medium processing device U4 by the third gate GT3. The third gate GT3 of the first example is configured using a thin film-shaped elastic member similarly to the second gate GT2. Therefore, the third gate GT3 temporarily causes the recording sheet S that has been transported through the reverse path SH4 to pass, and guides the recording sheet S toward the circulation path SH6 when the passing recording sheet S is switched back.

The recording sheet S transported to the circulation path SH6 is sent again to the secondary transfer region Q4 through the medium transport path SH2, and printing on the second side is performed.

The above-described elements denoted by references SH1 to SH7 constitute a sheet transport path SH. In addition, the above-described elements denoted by SH, Ra, Rr, Rh, SGr, SG1, SG2, BH, and GT1 to GT3 constitute a sheet transport device SU of the first example.

### Description of Transfer Assist Material Supply Device

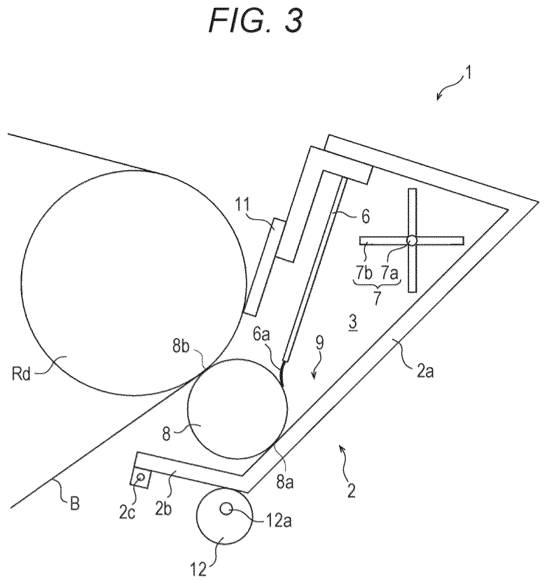

FIG. 3 is an explanatory view of a transfer assist material supply device of the first example.

In FIG. 3, the applying device TB includes a housing 2 which is an example of a casing. The housing 2 includes a sidewall 2a extending in the substantially up-down direction and a bottom plate 2b extending from a lower end of the sidewall 2a toward the intermediate transfer belt B. In addition, the housing 2 is supported to be rotatable about a rotation center 2c at a lower left portion.

A storage chamber 3 which is an example of a storage section is disposed inside the housing 2. The storage chamber 3 of the first example is surrounded by the sidewall 2a and a shielding plate 6 which is an example of a shielding section disposed between the sidewall 2a and the intermediate transfer belt B. Particles of powdery silica (SiO₂), which is an example of the transfer assist material, are accommodated in the storage chamber 3. Silica is known as an external additive which is externally added to the developer for the purpose of assisting transfer, and those similar to the external additive can be used. Therefore, silica has particles whose diameter is smaller than that of the developer, and an example, particles having a diameter in the order of 100 nm can be used. Although silica is exemplified as the transfer assist material, the invention is not limited thereto, and any material that can be used as the transfer assist material can be used.

A paddle 7 which is an example of a transport section is disposed above the storage chamber 3. The paddle 7 includes a rotation shaft 7a and a plate-shaped paddle body 7b radially extending from the rotation shaft 7a. A driving force is transmitted to the rotation shaft 7a from a motor which is an example of a driving source (not illustrated). Therefore, when the paddle 7 rotates about the rotation shaft 7a, silica in the storage chamber 3 is transported downward (toward a supply roller 8 to be described below).

In FIG. 3, the supply roller 8 which is an example of an assist material holding section is disposed in a lower portion of the storage chamber 3. The supply roller 8 is rotatable by receiving the driving force from the motor which is the example of the driving source (not illustrated). The silica particles from the storage chamber 3 are supplied to a surface of the supply roller 8. The supply roller 8 is made of, as an example, a foam material having a large number of surface irregularities and is capable of holding the silica particles in recessed portions. Note that a member having irregularities formed on its surface by bead blasting or the like can also be used without being limited to the foamed material. Sizes of the irregularities can be selected in accordance with a particle size of the transfer assist material. In the case of particles in the order of 100 nm, the irregularities can be formed to have diameters of about 100 to 200 μm.

The supply roller 8 is disposed to be in contact with the sidewall 2a at an opposing position 8a, and a wedge-shaped space 9, which is an example of a reservoir, is formed in a lower end portion of the storage chamber 3 by a space surrounded by the surface of the supply roller 8 and the sidewall 2a. Therefore, silica is held and supplied to the supply roller 8 in the wedge-shaped space 9.

The supply roller 8 supplies silica to the intermediate transfer belt B at a supply position 8b where the supply roller 8 opposes and comes into contact with the intermediate transfer belt B.

A rotation speed of the supply roller 8 of the first example is preferably set such that a linear speed (surface movement speed) at the supply position 8b is not the same speed as a linear speed of the intermediate transfer belt B but has a speed difference or a peripheral speed difference. In a case where the supply roller 8 is made of the foamed material, unevenness is likely to occur in the surface irregularities, and unevenness sometimes occurs even in an amount of silica to be supplied. In the case of the same speed, the unevenness on the supply roller 8 is likely to cause unevenness even on the intermediate transfer belt B. In the case of providing the speed difference, however, the surface of the supply roller 8 moves relative to the surface of the intermediate transfer belt B, and a portion where the unevenness in the supplied amount occurs is pushed by the relatively moving surface and is likely to be leveled, which is preferable.

In FIG. 3, a shielding film 6a is disposed between the supply roller 8 and the shielding plate 6. Therefore, the shielding film 6a partitions a space to prevent silica powder from pouring into the intermediate transfer belt B from the storage chamber 3.

A leveling blade 11 which is an example of a leveling section is disposed on the downstream side of the supply position 8b in the rotation direction of the intermediate transfer belt B. The leveling blade 11 comes into contact with the surface of the intermediate transfer belt B and levels a layer thickness of silica supplied to the surface of the intermediate transfer belt B. Therefore, for example, when coarse powder as aggregates of silica particles is supplied to the surface of the intermediate transfer belt B, the coarse powder is removed or broken by the leveling blade 11.

The leveling blade 11 can be configured using the same member as a cleaning blade 16 of the belt cleaner CLB. Note that the purpose of the leveling blade 11 is different from that of the cleaning blade 16 for removing the residues from the intermediate transfer belt B, and the leveling blade 11 has a smaller (shallower) contact angle with respect to the intermediate transfer belt B than that of the cleaning blade 16, and has a lower ability to remove the residues than that of the cleaning blade 16.

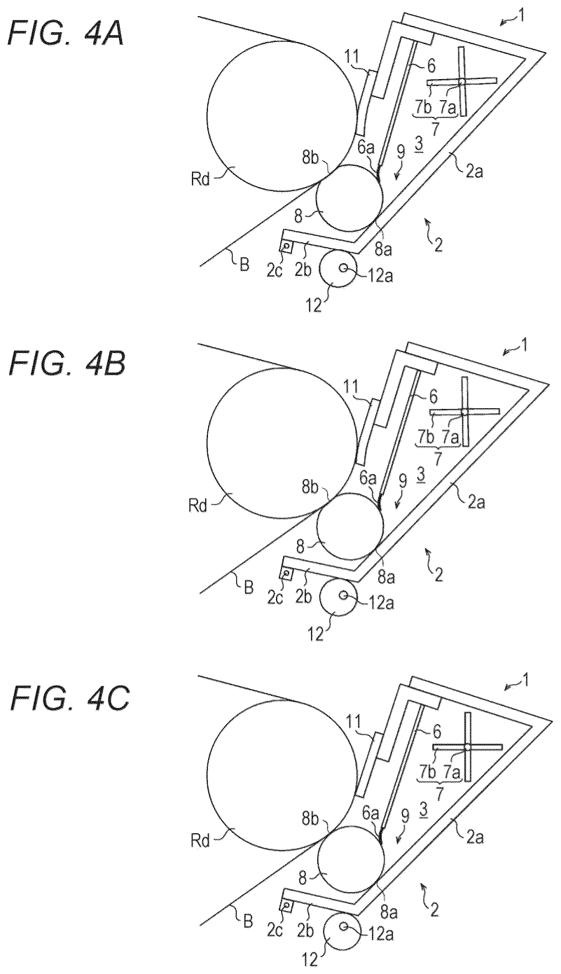

FIGS. 4A to 4C are explanatory views of movements of the applying device and the belt cleaner in which FIG. 4A is an explanatory view of a state where both the applying device and the belt cleaner are moved to a high contact pressure position, FIG. 4B is an explanatory view of a state where both the applying device and the belt cleaner are moved to a medium contact pressure position, and FIG. 4C is an explanatory view of a state where both the applying device and the belt cleaner are moved to a low contact pressure position.

In addition, an applying device moving cam 12 which is an example of a contact pressure adjustment section is disposed outside the housing 2. The applying device moving cam 12 is configured using a disk-shaped member and has a rotation shaft 12a provided at a position shifted from the center of the disk. That is, the applying device moving cam 12 is configured using a so-called eccentric cam. A driving force is transmitted from a motor (not illustrated) to the rotation shaft 12a. Therefore, as the applying device moving cam 12 rotates, the applying device TB is movable among the high contact pressure position illustrated in FIG. 4A where the contact pressure between the supply roller 8 and the intermediate transfer belt B is high, the medium contact pressure position illustrated in FIG. 4B where the contact pressure between the supply roller 8 and the intermediate transfer belt B is lower than that at the high contact pressure position, and the low contact pressure position illustrated in FIG. 4C where the contact pressure between the supply roller 8 and the intermediate transfer belt B is lower than that at the medium contact pressure position.

In addition, the belt cleaner CLB of the first example is supported to be rotatable about a rotation shaft 17 at a lower left portion, which is similar to the applying device TB. In addition, the belt cleaner CLB is provided with a cleaner moving cam 18 which is an example of a second contact pressure adjustment section. The cleaner moving cam 18 is configured similarly to the applying device moving cam 12. As the cleaner moving cam 18 rotates, the belt cleaner CLB of the first example is movable among a second high contact pressure position illustrated in FIG. 4A where the contact pressure between the cleaning blade 16 which is an example of a cleaning section and the intermediate transfer belt B is high, a second medium contact pressure position illustrated in FIG. 4B where the contact pressure between the cleaning blade 16 and the intermediate transfer belt B is lower than that at the second high contact pressure position, and a second low contact pressure position illustrated in FIG. 4C where the contact pressure between the cleaning blade 16 and the intermediate transfer belt B is lower than that at the second medium contact pressure position.

Although the configuration in which adjustment is performed at three steps of the high contact pressure position, the medium contact pressure position, and the low contact pressure position in the applying device TB of the first example is exemplified, the invention is not limited thereto. The number of steps can also be set to two, four, or more, or set to zero by continuously changing the contact pressure. Although the case where the supply roller 8 and the intermediate transfer belt B are in contact with each other at the low contact pressure position is exemplified, the invention is not limited thereto, and a separation position where the supply roller 8 and the intermediate transfer belt B are separated from each other, that is, a state where no transfer assist material is supplied can also be used.

Note that the belt cleaner CLB can also be similarly controlled in two steps, four steps, or more steps, or steplessly and it is also possible to use the second separation position at which the cleaning blade 16 and the intermediate transfer belt B are separated from each other, that is, a state where no transfer assist material is removed.

### Description Of Control Unit of First Example

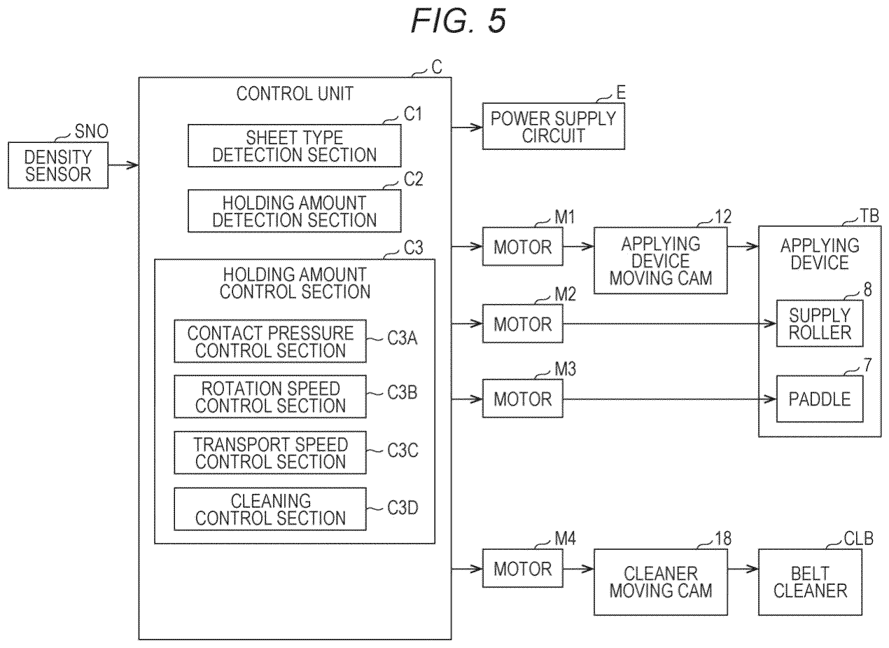

FIG. 5 is an explanatory diagram of a control unit of the first example.

In FIG. 5, a control unit (controller) C which is an example of a control section of the copier U includes an input/output interface I/O that performs input and output of signals to and from the outside. The, the control unit C includes a read-only memory (ROM) that stores programs, information, and the like for performing necessary processing. The control unit C further includes a random access memory (RAM) configured to temporarily store necessary data. The control unit C further includes a central processing unit (CPU) that performs processing according to the programs stored in the ROM and the like. Therefore, the control unit C of the first example is configured using a small-size information processing apparatus, that is, a so-called microcomputer. Thus, the control unit C can implement various functions by executing the programs stored in the ROM and the like.

The control unit C of the first example receives an input of a signal from a signal output element and outputs a signal to an element to be controlled to perform control.

### Description of Signal Output Element

The control unit C receives an input of a signal from a signal output element such as the density sensor SN0 or a sensor (not illustrated).

The density sensor SN0 detects the density of an image on the intermediate transfer belt B based on an amount of light reflected from the intermediate transfer belt B.

### Description of Element to be Controlled

The control unit C outputs a signal to an element to be controlled such as a power supply circuit E, a motor M1 which is an example of a driving section that moves the applying device TB, a motor M2 which is an example of a driving section that rotates the supply roller 8, a motor M3 which is an example of a driving section that rotates the paddle 7, and a motor M4 which is an example of a driving section that moves the belt cleaner CLB.

Although the configuration in which the motors M1 to M4 are separately provided is exemplified in the first example, the invention is not limited thereto, and a configuration in which a common motor is provided and a driving force is transmitted using a gear train and a clutch can also be employed.

### Functions of Control Unit C

The control unit C of the first example includes the following functional sections (functional modules and program modules) C1 to C3.

A sheet type detection section C1, which is an example of a medium type detection section, detects a sheet type such as plain paper, thick paper, or thin paper as an example of a type of the recording sheet S. In a case where a user inputs a type (a sheet type or a size) of a recording sheet through the UI, the sheet type detection section C1 detects information on the input type as the type of the recording sheet S.

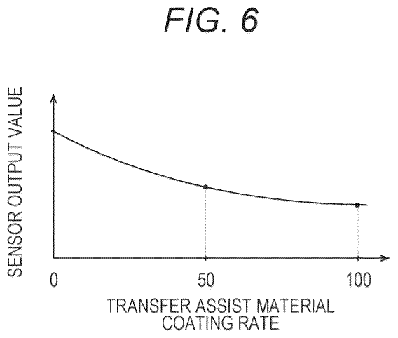

FIG. 6 is an explanatory view of an example of the relationship between an adhesion amount of the transfer assist material and an output of the density sensor, and is a graph in which the horizontal axis represents a coating rate and the vertical axis represents an output value of the density sensor.

A holding amount detection section C2 detects an amount (a holding amount) of the transfer assist material held on the intermediate transfer belt B. The holding amount detection section C2 of the first example detects the holding amount of the transfer assist material based on a detection result of the density sensor SN0. As illustrated in FIG. 6, it is known in advance by an experiment or the like that a detection value of the density sensor SN0 changes as the holding amount and the coating rate of the transfer assist material increase, and the holding amount of the transfer assist material can be estimated and detected from the detection result of the density sensor SN0.

The holding amount control section C3 includes a contact pressure control section C3A, a rotation speed control section C3B, a transport speed control section C3C, and a cleaning control section C3D, and controls a holding amount of the transfer assist material to be held on the intermediate transfer belt B. The holding amount control section C3 of the first example controls the contact pressure between the supply roller 8 and the intermediate transfer belt B, the rotation speed of the supply roller 8, the rotation speed of the paddle 7, and the contact pressure between the cleaning blade 16 and the intermediate transfer belt B based on the holding amount of the intermediate transfer belt B detected by the holding amount detection section C2 from a reading result of the density sensor SN0, thereby controlling the supply amount of the transfer assist material from the applying device TB to the intermediate transfer belt B and the holding amount of the transfer assist material on the intermediate transfer belt B. In a case where the recording sheet S to be used is a predetermined sheet type, such as Japanese paper or embossed paper, on which transfer failure is likely to occur the holding amount control section C3 of the first example performs control such that the holding amount of the transfer assist material becomes a predetermined amount obtained by an experiment or the like. In a case where the recording sheet S to be used is a sheet type, such as plain paper, on which the transfer failure is less likely to occur, the holding amount is controlled to be smaller than that in the case of the Japanese paper or the like. In the first example, as an example, control is performed such that the holding amount is zero, that is, a state where the transfer assist material is not present on the intermediate transfer belt B is obtained.

The contact pressure control section C3A controls the applying device moving cam 12 via the motor MI to move the applying device TB among the high contact pressure position to the low contact pressure position. The contact pressure control section C3A of the first example controls the supply amount of the transfer assist material to the intermediate transfer belt B by moving the applying device TB to the medium contact pressure position so as to compensate for the transfer assist material decreasing during execution of image formation in a case where the amount of the transfer assist material detected by the holding amount detection section C2 approximates a target holding amount, that is, falls within a predetermined range with respect to the target holding amount.

In a case where the amount of the transfer assist material is insufficient with respect to the target holding amount, the contact pressure control section C3A moves the applying device TB to the high contact pressure position so as to increase the contact pressure of the supply roller 8 with respect to the intermediate transfer belt B, thereby increasing the supply amount of the transfer assist material to the intermediate transfer belt B. Thus, an amount of the transfer assist material to be held on the intermediate transfer belt B is likely to be close to the target amount.

Further, in a case where the amount of the transfer assist material is excessive with respect to the target holding amount, the contact pressure control section C3A moves the applying device TB to the low contact pressure position so as to decrease the contact pressure of the supply roller 8 with respect to the intermediate transfer belt B, thereby reducing the amount of the transfer assist material supplied to the intermediate transfer belt B. Thus, an amount of the transfer assist material to be held on the intermediate transfer belt B is likely to be close to the target amount.

As described above, in a case where the applying device TB is movable to the separation position at which the supply roller 8 and the intermediate transfer belt B are separated from each other, the applying device TB is moved to the separation position to stop the supply of the transfer assist material when the amount of the transfer assist material is excessive with respect to the target holding amount, whereby the amount of the transfer assist material held by the intermediate transfer belt B is likely to be brought close to the target amount more quickly than at the low contact pressure position.

The rotation speed control section C3B controls the motor M2 to control the rotation speed of the supply roller 8 of the applying device TB. In a case where the amount of the transfer assist material detected by the holding amount detection section C3B approximates the target holding amount, the rotation speed control section C2 of the first example rotates the supply roller 8 at a predetermined rotation speed to compensate for the transfer assist material decreasing during execution of image formation. Thus, the peripheral speed difference between the supply roller 8 and the intermediate transfer belt B becomes a predetermined peripheral speed difference, and the predetermined amount of the transfer assist material is fed to the intermediate transfer belt B.

In a case where the amount of the transfer assist material is insufficient with respect to the target holding amount, the rotation speed control section C3B of the first example increases the speed of the supply roller 8 to increase the peripheral speed difference from the intermediate transfer belt B, thereby increasing the supply amount of the transfer assist material with respect to the intermediate transfer belt B. Thus, an amount of the transfer assist material to be held on the intermediate transfer belt B is likely to be close to the target amount.

Further, in a case where the amount of the transfer assist material is excessive with respect to the target holding amount, the rotation speed control section C3B reduces the speed of the supply roller 8 to decrease the peripheral speed difference from the intermediate transfer belt B, thereby decreasing the supply amount of the transfer assist material with respect to the intermediate transfer belt B. Thus, an amount of the transfer assist material to be held on the intermediate transfer belt B is likely to be close to the target amount.

The transport speed control section C3C controls the motor M3 to control the rotation speed of the paddle 7 of the applying device TB, thereby controlling a transport speed of the transfer assist material at the paddle 7. The transport speed control section C3C of the first example rotates the paddle 7 at a predetermined rotation speed in a case where the amount of the transfer assist material detected by the holding amount detection section C2 approximates the target holding amount. Thus, the predetermined transfer assist material is transported toward the supply roller 8 by the paddle 7, and the predetermined amount of the transfer assist material is supplied to the intermediate transfer belt B. In a case where the amount of the transfer assist material is insufficient with respect to the target holding amount, the transport speed control section C3C of the first example increases the speed of the paddle 7 to increase the supply amount of the transfer assist material with respect to the supply roller 8. Further, in a case where the amount of the transfer assist material is excessive with respect to the target holding amount, the transport speed control section C3C decreases the speed of the paddle 7 to decrease the supply amount of the transfer assist material with respect to the supply roller 8.

The cleaning control section C3D controls the cleaner moving cam 18 via the motor M4 to move the belt cleaner CLB among the second high contact pressure position to the second low contact pressure position. Therefore, the cleaning control section C3D controls the contact pressure of the cleaning blade 16 to control the amount of the transfer assist material to be removed from the intermediate transfer belt B, thereby controlling the amount of the transfer assist material to be held on the intermediate transfer belt B.

In a case where the amount of the transfer assist material detected by the holding amount detection section C2 approximates the target holding amount, that is, falls within the predetermined range with respect to the target holding amount, the cleaning control section C3D of the first example moves the belt cleaner CLB to the second medium contact pressure position to remove the transfer assist material from the intermediate transfer belt B by a predetermined removal amount.

In a case where the amount of the transfer assist material is insufficient with respect to the target holding amount, the cleaning control section C3D moves the belt cleaner CLB to the second low contact pressure position to decrease the contact pressure of the cleaning blade 16 with respect to the intermediate transfer belt B, thereby decreasing the amount of the transfer assist material to be removed from the intermediate transfer belt B. Further, in a case where the amount of the transfer assist material is excessive with respect to the target holding amount, the cleaning control section C3D moves the belt cleaner CLB to the second high contact pressure position to increase the removal amount of the transfer assist material from the intermediate transfer belt B. Thus, an amount of the transfer assist material to be held on the intermediate transfer belt B is likely to be close to the target amount.

As described above, in a case where the belt cleaner CLB is movable to the second separation position at which the cleaning blade 16 and the intermediate transfer belt B are separated from each other, the belt cleaner CLB is moved to the second separation position to stop the removal of the transfer assist material when the amount of the transfer assist material is insufficient with respect to the target holding amount, whereby the amount of the transfer assist material held by the intermediate transfer belt B is likely to be brought close to the target amount more quickly than at the second low contact pressure position.

### Effects of First Example

In the copier U of the first example having the above-described configuration, the amount of the transfer assist material held on the intermediate transfer belt B is detected by the density sensor SN0, and the supply amount from the applying device TB and the removal amount by the belt cleaner CLB are controlled based on the detected holding amount, so that the holding amount of the transfer assist material is controlled to the target holding amount. In a technique described in JP2008-175849A, a transfer assist material is randomly applied regardless of the amount of the transfer assist material actually adhering to a surface of an image holding section, and there is a possibility that the transfer assist material is excessively supplied to a portion where the transfer assist material is sufficiently held or the transfer assist material is not supplied to a portion where the transfer assist material is insufficient. Therefore, in the technique described in JP2008-175849A, there is a possibility that unevenness of the transfer assist material occurs, and transfer unevenness may occur. In particular, the transfer unevenness is likely to occur particularly on embossed paper or the like on which transfer failure is likely to occur, and there is a possibility that image quality of an image transferred and fixed to the recording sheet S is unstable. On the other hand, in the copier U of the first example, depending on the holding amount of the transfer assist material detected by the density sensor SN0, the supply amount is increased in a case where the transfer assist material is insufficient, and the supply amount is decreased in a case where the transfer assist material is excessive. Therefore, the unevenness of the transfer assist material on the intermediate transfer belt B is suppressed, and the occurrence of transfer unevenness is suppressed. Thus, the image quality is more stable as compared with the case of JP2008-175849A in which a supply amount of the transfer assist material with respect to the image holding section is not checked.

Note that the configuration in which four values of the contact pressure between the supply roller 8 and the intermediate transfer belt B, the rotation speed of the supply roller 8, the rotation speed of the paddle 7, and the contact pressure of the cleaning blade 16 are controlled is exemplified in the first example, but the invention is not limited thereto. It is also possible to adopt a configuration in which only any one to three of the four values are controlled and the other is not controlled (the contact pressure or the rotation speed is made constant).

### SECOND EXAMPLE

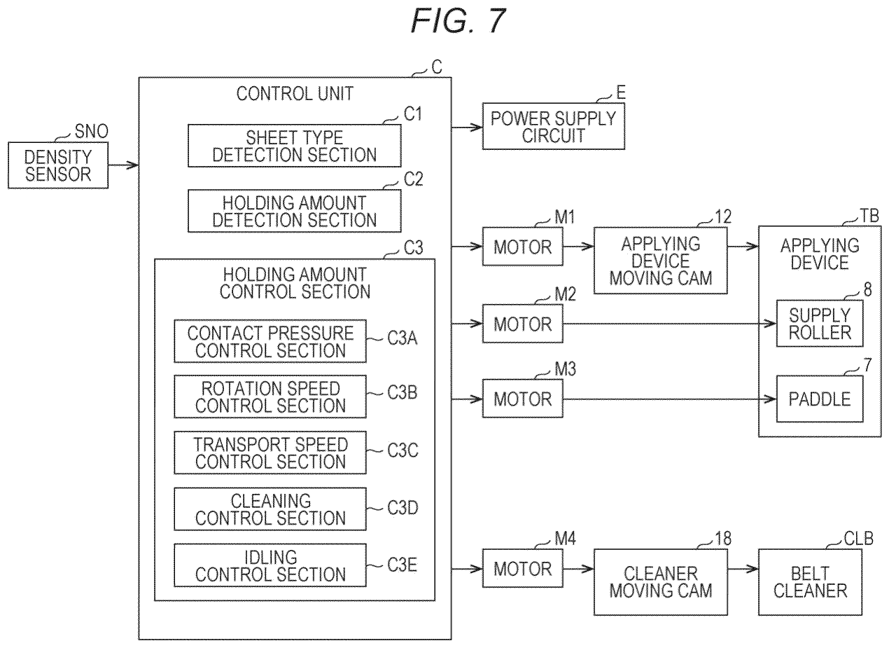

FIG. 7 is an explanatory diagram of a control unit of a second example, which corresponds to FIG. 5 of the first example.

Although the second example of the present invention will be described next, differences from the first example will be mainly described, the same configurations as those in the first example will be denoted by the same references, and detailed description thereof will be omitted.

In FIG. 7, in the copier U of the second example, the holding amount control section C3 of the control unit C includes an idling control section C3E. In addition, the applying device TB of the second example is configured to be movable to a separation position (not illustrated) at which the supply roller 8 is separated from the intermediate transfer belt B in addition to a high contact pressure position, a medium contact pressure position, and a low contact pressure position. Therefore, in the applying device TB of the second example, a transfer assist material is supplied to the intermediate transfer belt B at the high contact pressure position to the low contact pressure position and is not supplied at the separation position. That is, the applying device TB of the second example is movable among the high contact pressure position to the low contact pressure position, which are examples of a supply position, and the separation position which is an example of a non-supply position.

The idling control section C3E of the second example moves the belt cleaner CLB to the second high contact pressure position via the cleaning control section C3D and moves the applying device TB to the separation position via the contact pressure control section C3A in a case where a sheet type of the recording sheet S to be used is not Japanese paper, embossed paper, or the like or in a case where an amount of the transfer assist material is excessive with respect to a target holding amount.

### Effects of Second Example

In the copier U of the second example having the above-described configuration, in the case where the transfer assist material on the intermediate transfer belt B is excessive or in a case of plain paper or the like that does not require the transfer assist material, the idling control section C3E is controlled such that the cleaning blade 16 removes the transfer assist material in a state where the supply of the transfer assist material from the applying device TB to the intermediate transfer belt B is stopped, thereby forming a so-called idling state of the intermediate transfer belt B. Thus, the transfer assist material on the surface of the intermediate transfer belt B can be more quickly decreased as compared with the first example in which the applying device TB is moved to the low contact pressure position in the case where the transfer assist material is excessive.

### THIRD EXAMPLE

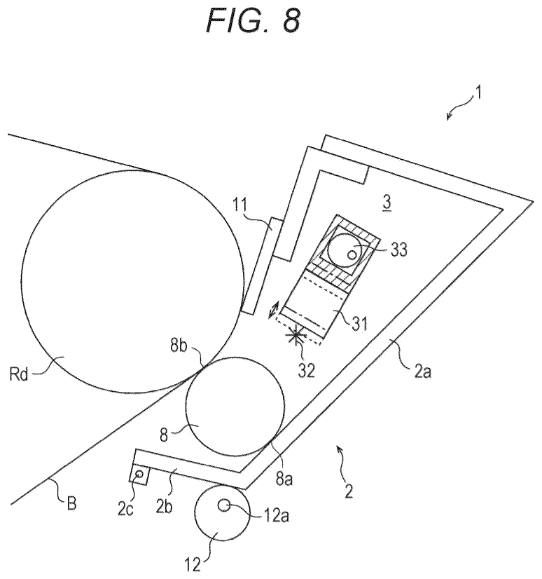

FIG. 8 is an explanatory view of a transfer assist material supply device of a third example, and corresponds to FIG. 3 of the first example.

Although the third example of the present invention will be described next, differences from the first example will be mainly described, the same configurations as those in the first example will be denoted by the same references, and detailed description thereof will be omitted.

In FIG. 8, in the applying device TB of the third example, the paddle 7 is not provided differently from The first example, and an assist material block 31 obtained by solidifying a transfer assist material in a solid form (a block shape) with an excipient or the like is used instead of the powdery transfer assist material in the first example. The assist material block 31 is disposed inside the storage chamber 3. A scraping brush 32 which is an example of a scraping section is disposed close to the assist material block 31. The assist material block 31 of the third example is supported so as to be movable in a direction of approaching or being separated from the scraping brush 32. The assist material block 31 is supported by the assist material block eccentric cam 33 so as to be movable among a third high contact pressure position (see broken lines in FIG. 8) at which a contact pressure with the scraping brush 32 is high, a medium contact pressure position (see solid lines in FIG. 8) at which the contact pressure with the scraping brush 32 is lower than that at the high contact pressure position, and a low contact pressure position (see alternate long and short dash lines in FIG. 8) at which the contact pressure with the scraping brush 32 is lower than that at the medium contact pressure position.

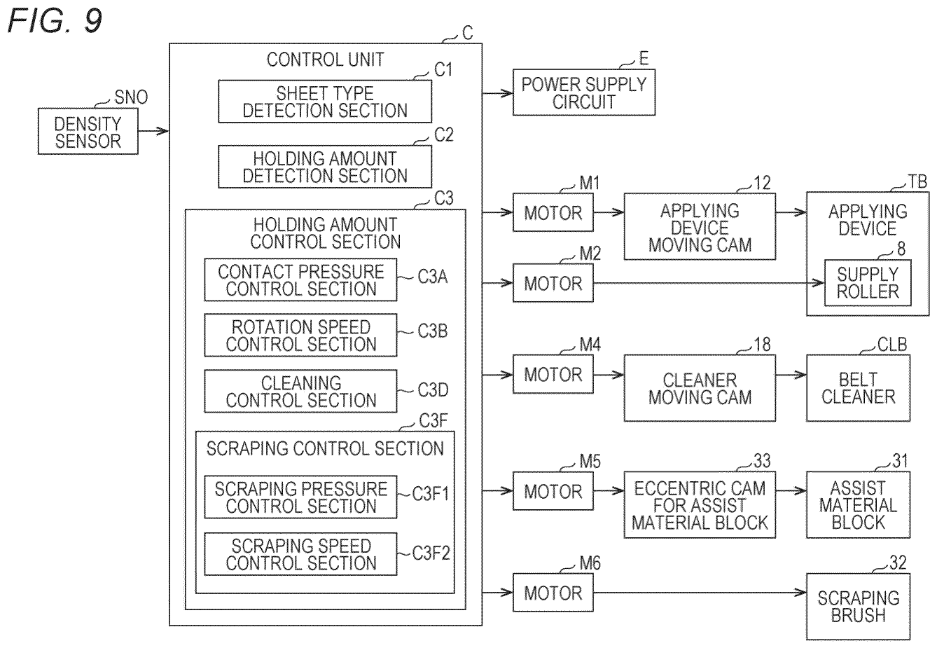

FIG. 9 illustrates a control unit of the third example, and corresponds to FIG. 5 illustrating the first example.

In FIG. 9, the control unit C of the third example does not include the transport speed control section C3C but includes a scraping control section C3F.

The scraping control section C3F includes a scraping pressure control section C3F1 and a scraping speed control section C3F2, controls scraping of the transfer assist material from the assist material block 31, and controls an amount of the transfer assist material supplied to the intermediate transfer belt B through the control of supplying the transfer assist material to the supplying roller 8.

The scraping pressure control section C3F1 controls a rotation position of the assist material block eccentric cam 33 via a motor M5, which is an example of a driving section, to move the assist material block 31 among the high contact pressure position to the low contact pressure position. In a case where the amount of the transfer assist material detected by the holding amount detection section C2 approximates a target holding amount, the scraping pressure control section C3F1 of the third example moves the assist material block 31 to the medium contact pressure position to bring the assist material block 31 into contact with the scraping brush 32 at a predetermined contact pressure. Thus, the transfer assist material is scraped off from the assist material block 31, and a predetermined amount of the powdery transfer assist material is dropped and stored in the wedge-shaped space 9 and then supplied to the supply roller 8.

In addition, in a case where the amount of the transfer assist material is insufficient with respect to the target holding amount, the scraping pressure control section C3F1 of the third example moves the assist material block 31 to the high contact pressure position to bring the assist material block 31 into contact with the scraping brush 32 at the contact pressure higher than that at the medium contact pressure position. Thus, the amount of the powdery transfer assist material scraped off from the assist material block 31 increases. Thus, the transfer assist material to be supplied to the supply roller 8 increases, and the amount of the transfer assist material to be held on the intermediate transfer belt B where the transfer assist material is insufficient is likely to be close to the target amount.

Further, in a case where the amount of the transfer assist material is excessive with respect to the target holding amount, the scraping pressure control section C3F1 moves the assist material block 31 to the low contact pressure position to bring the assist material block 31 into contact with the scraping brush 32 at the contact pressure lower than that at the medium contact pressure position. Thus, the amount of the powdery transfer assist material scraped off from the assist material block 31 decreases. Thus, the transfer assist material to be supplied to the supply roller 8 decreases, and the amount of the transfer assist material to be held on the intermediate transfer belt B where the transfer assist material is excessive is likely to be brought close to the target amount.

The scraping speed control section C3F2 controls a rotation position of the scraping brush 32 via a motor M6 which is an example of a driving section. The scraping speed control section C3F2 of the third example rotates the scraping brush 32 at a predetermined rotation speed in a case where the amount of the transfer assist material detected by the holding amount detection section C2 approximates the target holding amount. Thus, a predetermined amount of the powdery transfer assist material is scraped off from the assist material block 31, dropped and stored in the wedge-shaped space 9, and then, supplied to the supply roller 8.

In addition, in the case where the amount of the transfer assist material is insufficient with respect to the target holding amount, the scraping speed control section C3F2 of the third example rotates the scraping brush 32 at a speed higher than that in the case where the amount of the transfer assist material approximates the target holding amount. Thus, the amount of the powdery transfer assist material scraped off from the assist material block 31 increases. Thus, the transfer assist material to be supplied to the supply roller 8 increases, and the amount of the transfer assist material to be held on the intermediate transfer belt B where the transfer assist material is insufficient is likely to be close to the target amount.

Further, in the case where the amount of the transfer assist material is excessive with respect to the target holding amount, the scraping speed control section C3F2 rotates the scraping brush 32 at a speed lower than that in the case where the amount of the transfer assist material approximates the target holding amount. Thus, the amount of the powdery transfer assist material scraped off from the assist material block 31 decreases. Thus, the transfer assist material to be supplied to the supply roller 8 decreases, and the amount of the transfer assist material to be held on the intermediate transfer belt B where the transfer assist material is excessive is likely to be brought close to the target amount.

### Effects of Third Example

In the copier U of the third example having the above-described configuration, if the amount of the transfer assist material on the intermediate transfer belt B is insufficient when the transfer assist material is scraped off from the solid assist material block 31 by the scraping brush 32 and is supplied in the powder form to the supply roller 8, the contact pressure between the assist material block 31 and the scraping brush 32 is increased, and the rotation speed of the scraping brush 32 is also increased. Thus, a scraping amount of the transfer assist material increases, a supply amount of the transfer assist material to the supply roller 8 increases, and a supply amount of the transfer assist material to the intermediate transfer belt B also increases. On the other hand, when the amount of the transfer assist material on the intermediate transfer belt B is excessive, the contact pressure between the assist material block 31 and the scraping brush 32 is decreased, and the rotational speed of the scraping brush 32 is also decreased. Thus, a scraping amount of the transfer assist material decreases, a supply amount of the transfer assist material to the supply roller 8 decreases, and a supply amount of the transfer assist material to the intermediate transfer belt B also decreases.

Therefore, in the copier U of the third example, the holding amount of the transfer assist material on the intermediate transfer belt B can be controlled by adjusting the amount of the transfer assist material scraped off from the solid assist material block 31 depending on the holding amount of the transfer assist material on the intermediate transfer belt B.

In addition, the solid assist material block 31 is used in the copier U of the third example, and thus, when the transfer assist material is consumed and is to be replenished, replenishing work facilitated as compared with the first and second examples in which the powdery transfer assist material is used from the beginning. That is, contamination is likely to occur due to scattering or floating in a case where powder is replenished. However, the replenishing work is facilitated in a case where the solid assist material block 31 is replaced.

Although the case where the contact pressure between the assist material block 31 and the scraping brush 32 is increased and the rotation speed of the scraping brush 32 is also increased when the amount of the transfer assist material on the intermediate transfer belt B is insufficient is exemplified in the third example, the invention is not limited thereto. It is also possible to change only one of the contact pressure and the rotation speed and control the other to be constant. Similarly, the case where the contact pressure between the assist material block 31 and the scraping brush 32 is decreased and the rotational speed of the scraping brush 32 is also decreased when the amount of the transfer assist material on the intermediate transfer belt B is excessive is exemplified, but it is also possible to change only one of the contact pressure and the rotational speed and control the other to be constant.

In addition, the scraping brush 32 is illustrated as the example of the scraping section, any form such as a roller shape or a paddle shape can also be adopted without being limited to the brush-shaped form. In addition, it is also possible to adopt a configuration in which the assist material block 31 is brought into direct contact with the supply roller 8 and the assist material block 31 is scraped off by the supply roller 8, that is, a configuration in which the supply roller 8 also functions as the scraping section.

### Modification

Although the examples of the present invention have been described above in detail, the present invention is not limited to the above-described examples, and various modifications can be made within the scope of the gist of the present invention described in the claims. Modifications (H01) to (H02) of the present invention will be exemplified as follows.

(H01) Although the copier U as the example of the image forming apparatus is illustrated in the above-described examples, the invention is not limited thereto and can also be applied to a facsimile or a multifunctional machine having a plurality of functions of the facsimile, a printer, a copier, and the like. In addition, the invention is not limited to the multi-color developing image forming apparatus, and can also be configured using a monochrome image forming apparatus. Further, the invention is not limited to the image forming apparatus, and can also be applied to any electronic device or mechanical device that uses a motor and a gear.

(H02) Although the intermediate transfer belt B as the example of the image holding section is illustrated in the above-described examples, the invention is not limited thereto, and can also be applied to a photoconductor or the like. Therefore, the image holding section is not limited to a belt-shaped member, and a drum-shaped member is also applicable.

### Supplementary Notes

(((1)))
An image forming apparatus comprising:
an image holding section;
a transfer section that transfers an image held by the image holding section onto a medium;
a supply section that supplies a transfer assist material for assisting the transfer to the image holding section;
a detection section that detects an amount of the transfer assist material held by the image holding section; and
a holding amount control section that controls an amount of the transfer assist material to be held by the image holding section based on a detection result of the detection section.

(((2)))

The image forming apparatus according to (((1))), wherein
the holding amount control section controls a supply amount of the transfer assist material to be supplied from the supply section to the image holding section to control the amount of the transfer assist material to be held by the image holding section.

(((3)))

The image forming apparatus according to (((2))), wherein
the supply section comprises a storage section that stores the transfer assist material, and an assist material holding section that comes into contact with the image holding section and rotates in a state of holding the transfer assist material.

(((4)))

The image forming apparatus according to (((3))), wherein
the holding amount control section increases a contact pressure of the assist material holding section with respect to the image holding section to increase the supply amount of the transfer assist material to the image holding section when the amount of the transfer assist material is insufficient.

(((5)))

The image forming apparatus according to (((3))) or (((4))), wherein
the holding amount control section decreases a contact pressure of the assist material holding section with respect to the image holding section to decrease the supply amount of the transfer assist material to the image holding section when the amount of the transfer assist material is excessive.

(((6)))

The image forming apparatus according to any one of (((3))) to (((5))), wherein
the holding amount control section increases a peripheral speed difference in rotation of the assist material holding section with respect to the image holding section to increase the supply amount from the supply section when the amount of the transfer assist material is insufficient.

(((7)))

The image forming apparatus according to any one of (((3))) to (((6))), wherein
the holding amount control section reduces a peripheral speed difference in rotation of the assist material holding section with respect to the image holding section to decrease the supply amount from the supply section when the amount of the transfer assist material is excessive.

(((8)))

The image forming apparatus according to any one of (((3))) to (((7))), wherein
the supply section comprises a transport section that transports the transfer assist material stored in the storage section toward the assist material holding section, and
the holding amount control section increases a transport amount by the transport section to increase the supply amount from the supply section when the amount of the transfer assist material is insufficient.

(((9)))

The image forming apparatus according to any one of (((3))) to (((8))), wherein
the supply section comprises a transport section that transports the transfer assist material stored in the storage section toward the assist material holding section, and
the holding amount control section decreases a transport amount by the transport section to decrease the supply amount from the supply section when the amount of the transfer assist material is excessive.

(((10)))

The image forming apparatus according to (((3))), wherein
the assist material holding section supplies a transfer assist material in a powder form scraped off from the transfer assist material in a solid form to the image holding section.

(((11)))

The image forming apparatus according to (((10))), further comprising
a scraping section that rotates in contact with the transfer assist material in the solid to scrape off the transfer assist material,
wherein the holding amount control section increases a contact pressure between the scraping section and the transfer assist material in the solid form to increase a scraping amount of the transfer assist material and increase the supply amount of the transfer assist material to the image holding section when the amount of the transfer assist material is insufficient.

(((12)))

The image forming apparatus according to (((10))) or (((11))), further comprising
a scraping section that rotates in contact with the transfer assist material in the solid to scrape off the transfer assist material,
wherein the holding amount control section decreases a contact pressure between the scraping section and the transfer assist material in the solid form to decrease a scraping amount of the transfer assist material and decrease the supply amount of the transfer assist material to the image holding section when the amount of the transfer assist material is excessive.

(((13)))

The image forming apparatus according to any one of (((10))) to (((12))), further comprising
a scraping section that rotates in contact with the transfer assist material in the solid to scrape off the transfer assist material,
wherein the holding amount control section increases a rotation speed of the scraping section to increase a scraping amount of the transfer assist material and increase the supply amount of the transfer assist material to the image holding section when the amount of the transfer assist material is insufficient.

(((14)))

The image forming apparatus according to any one of (((10))) to (((13))), further comprising
a scraping section that rotates in contact with the transfer assist material in the solid to scrape off the transfer assist material,
wherein the holding amount control section decreases a rotation speed of the scraping section to decrease a scraping amount of the transfer assist material and decrease the supply amount of the transfer assist material to the image holding section when the amount of the transfer assist material is excessive.

(((15)))

The image forming apparatus according to any one of (((1))) to (((14))), further comprising
a cleaning section that is disposed on an upstream side of the supply section with respect to a rotation direction of the image holding section and comes into contact with a surface of the image holding section after the transfer to clean the image holding section,
wherein the holding amount control section controls removal of the transfer assist material by the cleaning section to control the amount of the transfer assist material to be held by the image holding section.

(((16)))

The image forming apparatus according to (((15))), wherein
the holding amount control section decreases a contact pressure of the cleaning section with respect to the image holding section to decrease an amount of the transfer assist material to be removed from the image holding section when the amount of the transfer assist material is insufficient.

(((17)))

The image forming apparatus according to (((16))), wherein
the holding amount control section separates the cleaning section from the image holding section.

(((18)))

The image forming apparatus according to (((16))) or (((17))), wherein
the holding amount control section increases the contact pressure of the cleaning section with respect to the image holding section to increase the amount of the transfer assist material to be removed from the image holding section when the amount of the transfer assist material is excessive.

(((19)))

The image forming apparatus according to (((18))), wherein
the contact pressure of the cleaning section with respect to the image holding section is increased, and the supply of the transfer assist material from the supply section is stopped.

(((20)))

The image forming apparatus according to any one of (((16))) to (((19))), wherein
the holding amount control section stops the supply of the transfer assist material from the supply section and makes the image holding section idle to cause the cleaning section to remove the transfer assist material when the amount of the transfer assist material is excessive.

What is claimed is:

1. An image forming apparatus comprising:
an image holding section;
a transfer section that transfers an image held by the image holding section onto a medium;
a supply section that supplies a transfer assist material for assisting the transfer to the image holding section;
a detection section that detects an amount of the transfer assist material held by the image holding section; and
a holding amount control section that controls an amount of the transfer assist material to be held by the image holding section based on a detection result of the detection section.

2. The image forming apparatus according to claim 1, wherein
the holding amount control section controls a supply amount of the transfer assist material to be supplied from the supply section to the image holding section to control the amount of the transfer assist material to be held by the image holding section.

3. The image forming apparatus according to claim 2, wherein
the supply section comprises a storage section that stores the transfer assist material, and an assist material holding section that comes into contact with the image holding section and rotates in a state of holding the transfer assist material.

4. The image forming apparatus according to claim 3, wherein
the holding amount control section increases a contact pressure of the assist material holding section with respect to the image holding section to increase the supply amount of the transfer assist material to the image holding section when the amount of the transfer assist material is insufficient.

5. The image forming apparatus according to claim 3, wherein
the holding amount control section decreases a contact pressure of the assist material holding section with respect to the image holding section to decrease the supply amount of the transfer assist material to the image holding section when the amount of the transfer assist material is excessive.

6. The image forming apparatus according to claim 3, wherein
the holding amount control section increases a peripheral speed difference in rotation of the assist material holding section with respect to the image holding section to increase the supply amount from the supply section when the amount of the transfer assist material is insufficient.

7. The image forming apparatus according to claim 3, wherein
the holding amount control section reduces a peripheral speed difference in rotation of the assist material holding section with respect to the image holding section to decrease the supply amount from the supply section when the amount of the transfer assist material is excessive.

8. The image forming apparatus according to claim 3, wherein
the supply section comprises a transport section that transports the transfer assist material stored in the storage section toward the assist material holding section, and
the holding amount control section increases a transport amount by the transport section to increase the supply amount from the supply section when the amount of the transfer assist material is insufficient.

9. The image forming apparatus according to claim 3, wherein
the supply section comprises a transport section that transports the transfer assist material stored in the storage section toward the assist material holding section, and
the holding amount control section decreases a transport amount by the transport section to decrease the supply amount from the supply section when the amount of the transfer assist material is excessive.

10. The image forming apparatus according to claim 3, wherein
the assist material holding section supplies a transfer assist material in a powder form scraped off from the transfer assist material in a solid form to the image holding section.

11. The image forming apparatus according to claim 10, further comprising
a scraping section that rotates in contact with the transfer assist material in the solid to scrape off the transfer assist material,
wherein the holding amount control section increases a contact pressure between the scraping section and the transfer assist material in the solid form to increase a scraping amount of the transfer assist material and increase the supply amount of the transfer assist material to the image holding section when the amount of the transfer assist material is insufficient.

12. The image forming apparatus according to claim 10, further comprising
a scraping section that rotates in contact with the transfer assist material in the solid to scrape off the transfer assist material,
wherein the holding amount control section decreases a contact pressure between the scraping section and the transfer assist material in the solid form to decrease a scraping amount of the transfer assist material and decrease the supply amount of the transfer assist material to the image holding section when the amount of the transfer assist material is excessive.

13. The image forming apparatus according to claim 10, further comprising
a scraping section that rotates in contact with the transfer assist material in the solid to scrape off the transfer assist material,
wherein the holding amount control section increases a rotation speed of the scraping section to increase a scraping amount of the transfer assist material and increase the supply amount of the transfer assist material to the image holding section when the amount of the transfer assist material is insufficient.

14. The image forming apparatus according to claim 10, further comprising
a scraping section that rotates in contact with the transfer assist material in the solid to scrape off the transfer assist material,
wherein the holding amount control section decreases a rotation speed of the scraping section to decrease a scraping amount of the transfer assist material and decrease the supply amount of the transfer assist material to the image holding section when the amount of the transfer assist material is excessive.

15. The image forming apparatus according to claim 1, further comprising
a cleaning section that is disposed on an upstream side of the supply section with respect to a rotation direction of the image holding section and comes into contact with a surface of the image holding section after the transfer to clean the image holding section,
wherein the holding amount control section controls removal of the transfer assist material by the cleaning section to control the amount of the transfer assist material to be held by the image holding section.

16. The image forming apparatus according to claim 15, wherein
the holding amount control section decreases a contact pressure of the cleaning section with respect to the image holding section to decrease an amount of the transfer assist material to be removed from the image holding section when the amount of the transfer assist material is insufficient.

17. The image forming apparatus according to claim 16, wherein
the holding amount control section separates the cleaning section from the image holding section.

18. The image forming apparatus according to claim 16, wherein
the holding amount control section increases the contact pressure of the cleaning section with respect to the image holding section to increase the amount of the transfer assist material to be removed from the image holding section when the amount of the transfer assist material is excessive.

19. The image forming apparatus according to claim 18, wherein
the contact pressure of the cleaning section with respect to the image holding section is increased, and the supply of the transfer assist material from the supply section is stopped.

20. The image forming apparatus according to claim 16, wherein
the holding amount control section stops the supply of the transfer assist material from the supply section and makes the image holding section idle to cause the cleaning section to remove the transfer assist material when the amount of the transfer assist material is excessive.
